(19) United States
(12) Patent Application Publication
(10) Pub. No.: US 2026/0292070 A1
(43) Pub. Date: Sep. 24, 2026

(54) SYSTEM AND METHOD FOR RESUMING A DISCONNECTED INBOUND-INTERACTION BETWEEN AN AGENT AND A CUSTOMER IN A CONTACT CENTER

(71) Applicant: NICE LTD., Ra'anana (IL)

(72) Inventors: Subhash PORJE, Pune (IN); Kalleshwar KALSHETTY, Pune (IN); Anuradha SINGH, Pune (IN)

(21) Appl. No.: 19/084,818

(22) Filed: Mar. 20, 2025

(51) Int. Cl. H04M 3/523; G10L 15/26

(52) U.S. Cl. CPC H04M 3/5232; G10L 15/26

(57) ABSTRACT

A computerized-method for resuming a disconnected inbound-interaction between an agent and a customer in a contact center. The computerized-method includes: (i) receiving a first inbound-interaction and distributing the first inbound-interaction to a first agent; (ii) generating a transcription-file of the first inbound-interaction and associating a customer id to it; (iii) detecting a disconnection event of the first inbound-interaction that is marked as disconnected-unexpectedly status by the first agent; (iv) analyzing the generated transcription file to yield interaction related data by using a pretrained AI model; (v) storing the yielded interaction related data and metadata of the first inbound-interaction; (vi) identifying a second inbound-interaction, and retrieving the stored interaction related data and metadata of the first inbound-interaction based on the customer id; and (vii) distributing the second inbound-interaction to a second agent and displaying the interaction related data and metadata of the first inbound-interaction via a UI on a display unit.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever

### TECHNICAL FIELD

The present disclosure relates to the field of contact center interactions, and more specifically to resuming a disconnected inbound-interaction between an agent and a customer in a contact center.

### BACKGROUND

In contact centers, when a customer is in the middle of explaining their issue to a contact center agent and the customer call gets disconnected, they face several problems. First the customer has to start over and describe their query from the beginning, which can be frustrating and time-consuming. Second, the new agent might not have the context or understanding of the issue that the previous agent had, leading to potential misunderstandings or incomplete assistance. Third, disconnections can lead to delays in resolving the issue as the customer has to restart the process, potentially causing them to wait longer to speak to another agent.

Therefore, there is a need for a technical solution for implementing a continuity transcript derived from customer-agent interactions which will assist both the agent and the customer in the event of a call disconnection, facilitating seamless reconnection and efficient query resolution.

Accordingly, there is a need for a technical solution for resuming a disconnected inbound-interaction between an agent and a customer in a contact center.

### SUMMARY

There is thus provided, in accordance with some embodiments of the present disclosure, a computerized-method for resuming a disconnected inbound-interaction between an agent and a customer in a contact center.

Furthermore, in accordance with some embodiments of the present disclosure, the computerized-method may include: (i) receiving a first inbound-interaction of a customer and distributing the first inbound-interaction to a first agent by an Automatic Call Distribution (ACD) application; (ii) automatically generating a transcription file of the first inbound-interaction in real-time by operating a transcribe service and associating a customer id of the customer to it; (iii) detecting a disconnection event of the first inbound-interaction that is marked as disconnected-unexpectedly status by the first agent via a User Interface (UI) that is associated to an application to handle the inbound-interaction; (iv) automatically analyzing the generated transcription file to yield interaction related data by using a pretrained Artificial intelligence (AI) model; (v) storing the yielded interaction related data and metadata of the first inbound-interaction in a database; (vi) identifying a second inbound-interaction of the customer by the ACD application based on the customer id and the disconnected-unexpectedly status, and automatically retrieving the stored interaction related data and metadata of the first inbound-interaction from the database based on the customer id; and (vii) distributing the second inbound-interaction to a second agent by the ACD application and displaying the interaction related data and metadata of the first inbound-interaction via the UI on a display unit.

Furthermore, in accordance with some embodiments of the present disclosure, when the first inbound-interaction is a voice interaction, recording the inbound-interaction to yield an audio file and operating speech-to-text technique on the audio file to generate the transcription file.

Furthermore, in accordance with some embodiments of the present disclosure, the pretrained AI model may be trained by feeding stored interaction related data and metadata of the first inbound-interaction and the transcription file to a Machine Learning (ML) platform.

Furthermore, in accordance with some embodiments of the present disclosure, the interaction related data may include at least one of: (i) summary of content of the inbound-interaction; (ii) customer queries; and (iii) discussion points, and the pretrained AI model may be configured to provide one or more resolutions to the discussion points.

Furthermore, in accordance with some embodiments of the present disclosure, after the first inbound-interaction is disconnected, the computerized-method may further include automatically connecting the customer to the second inbound-interaction.

Furthermore, in accordance with some embodiments of the present disclosure, after the identifying of the second inbound-interaction of the customer by the ACD application, the computerized-method may further include sending the interaction related data via a digital communication channel to the customer before distributing the second inbound-interaction to the second agent by the ACD application.

There is further provided, in accordance with some embodiments of the present disclosure, a computerized-system for resuming a disconnected inbound-interaction between an agent and a customer in a contact center.

Furthermore, in accordance with some embodiments of the present disclosure, the computerized-system may include: an Automatic Call Distribution (ACD) application; a User Interface (UI); a display unit; a database, and one or more processors.

Furthermore, in accordance with some embodiments of the present disclosure, upon receiving a first inbound-interaction of a customer and distributing the first inbound-interaction to a first agent by the ACD application, the one or more processors may be configured to: (i) receive a first inbound-interaction of a customer and distributing the first inbound-interaction to a first agent by the ACD application; (ii) automatically generate a transcription file of the first inbound-interaction in real-time by operating a transcribe service and associating a customer id of the customer to it; (iii) detect a disconnection event of the first inbound-interaction that is marked as disconnected-unexpectedly status by the first agent via a User Interface (UI) that is associated to an application to handle the inbound-interaction; (iv) automatically analyze the generated transcription file to yield interaction related data by using a pretrained Artificial intelligence (AI) model; (v) store the yielded interaction related data and metadata of the first inbound-interaction in a database; (vi) identify a second inbound-interaction of the customer by the ACD application based on the customer id and the disconnected-unexpectedly status, and automatically retrieving the stored interaction related data and metadata of the first inbound-interaction from the database based on the customer id; and (vii) distribute the second inbound-interaction to a second agent by the ACD application and displaying the interaction related data and metadata of the first inbound-interaction via the UI on the display unit.

### BRIEF DESCRIPTION OF THE DRAWINGS

FIG. 1 schematically illustrates a high-level diagram of a system for resuming a disconnected inbound-interaction between an agent and a customer in a contact center, in accordance with some embodiments of the present disclosure;

FIGS. 2A-2B are a high-level workflow of resuming a disconnected inbound-interaction between an agent and a customer in a contact center, in accordance with some embodiments of the present disclosure;

FIG. 3 schematically illustrates a high-level diagram of a system for resuming a disconnected inbound-interaction between an agent and a customer in a contact center, in accordance with some embodiments of the present disclosure;

FIG. 4 is a screenshot of the output of real-time transcription service, in accordance with some embodiments of the present disclosure;

FIG. 5 is a high-level workflow of routing calls through an Automatic Call Distribution (ACD) application, in accordance with some embodiments of the present disclosure;

FIG. 6 is a detailed high-level workflow of routing calls through an ACD application, in accordance with some embodiments of the present disclosure;

FIG. 7 is a high-level workflow of a transcription service, in accordance with some embodiments of the present disclosure;

FIG. 8 is a detailed high-level workflow of a transcription service, in accordance with some embodiments of the present disclosure;

FIG. 9 is a high-level workflow of a pretrained Artificial intelligence (AI) model initiation, in accordance with some embodiments of the present disclosure;

FIG. 10 is a high-level workflow of dataset preparation for the pretrained AI model, in accordance with some embodiments of the present disclosure;

FIG. 11 is a high-level workflow of ACD application operation after a call is disconnected, in accordance with some embodiments of the present disclosure;

FIG. 12 is a high-level workflow of Quality Management (QM) application operations after a call is disconnected, in accordance with some embodiments of the present disclosure; and

FIG. 13 is a screenshot of interaction related data and metadata of an inbound-interaction presented via the UI on a display unit, in accordance with some embodiments of the present disclosure.

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

When a customer is in the middle of explaining their issue to a contact center agent and the customer call gets disconnected, they face repetition of information, loss of context and extended resolution time.

Therefore, there is a need for method and system for resuming a disconnected inbound-interaction between an agent and a customer in a contact center.

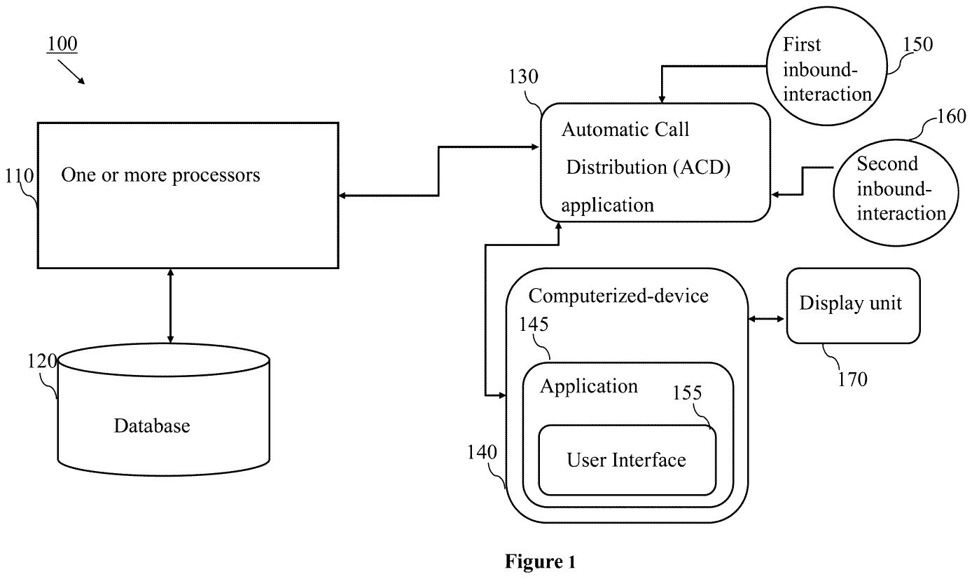

FIG. 1 schematically illustrates a high-level diagram of a system 100 for resuming a disconnected inbound-interaction between an agent and a customer in a contact center, in accordance with some embodiments of the present disclosure.

According to some embodiments of the present disclosure, a computerized system, such as system 100 may resume a disconnected inbound-interaction between an agent and a customer in a contact center.

According to some embodiments of the present disclosure, after receiving a first inbound-interaction 150 of a customer and distributing the first inbound-interaction 150 to an agent by an Automatic Call Distribution (ACD) application 130, system 100 may generate a continuity transcript derived from customer-agent interactions. The transcript may assist both the agent and the customer in the event of a call disconnection, facilitating seamless reconnection and efficient query resolution.

According to some embodiments of the present disclosure, when the first inbound-interaction 150 may disconnect unexpectedly, the agent may mark the case status as ‘Disconnected Unexpectedly’ via the User Interface (UI) 155 that is associated to the application 145 and then system 100 may generate a unique session ID for the first inbound-interaction 150, in addition to utilizing voice recognition, security questions, or other authentication methods to confirm the customer's identity and link it to the previous call.

According to some embodiments of the present disclosure, optionally, the first inbound-interaction 150 may be tagged to label e.g., “disconnected call”. When the customer may call again, another agent may quickly see the tags associated with the customer profile and summary of previous interactions. Based on the stored context of a disconnected call, the next call, e.g., second inbound-interaction 160 can resume from where it left off, without the customer needing to provide the context again to the agent.

According to some embodiments of the present disclosure, transcription technologies may be used to leverage transcripts dynamically in real-time for call continuity by using Natural Language Processing (NLP), predictive analytics, and system integration.

According to some embodiments of the present disclosure, the one or more processors 110 may be configured to operate a transcribe service to generate the transcription file of the first inbound-interaction 150 in real-time. A customer id may be associated to the transcription file.

According to some embodiments of the present disclosure, the one or more processors 110 may be configured to detect a disconnection event of the first inbound-interaction 150 that is marked as disconnected-unexpectedly status by the first agent via the UI 155 that is associated to the application 145 to handle the inbound-interaction.

According to some embodiments of the present disclosure, the generated transcription file may be automatically analyzed to yield interaction related data by using a pretrained Artificial intelligence (AI) model. The yielded interaction related data and metadata of the first inbound-interaction 150 may be stored in a database 120.

According to some embodiments of the present disclosure, when a second inbound-interaction 160 of the customer may be identified by the ACD application 130 based on the customer id and the disconnected-unexpectedly status, the stored interaction related data and metadata of the first inbound-interaction may be automatically retrieved from the database 120 based on the customer id.

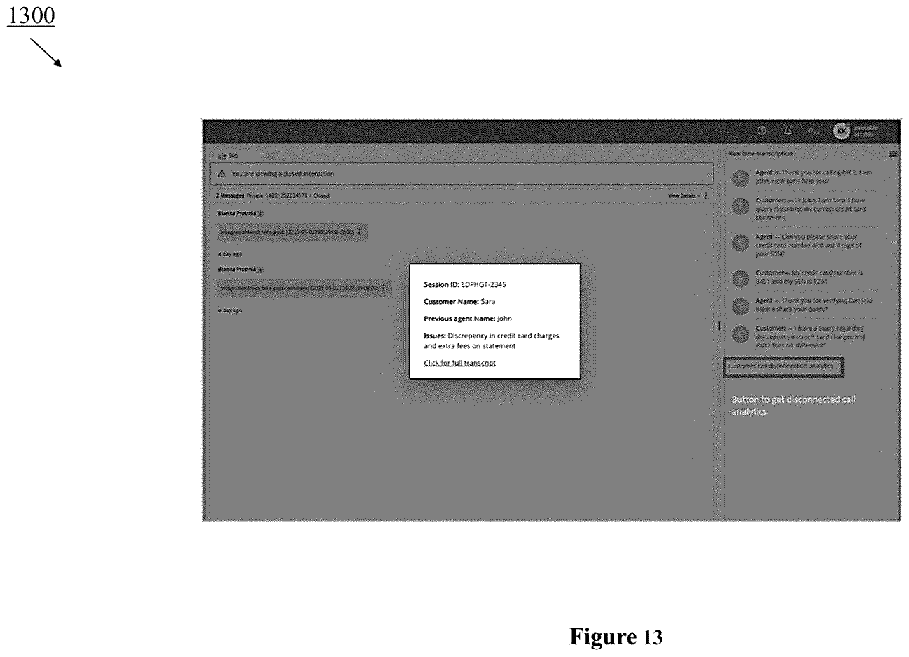

According to some embodiments of the present disclosure, the second inbound-interaction may be distributed to another agent by the ACD application 130 and the interaction related data and metadata of the first inbound-interaction may be displayed via the UI 155 on a display unit 170. For example, as shown in screenshot 1300 in FIG. 13.

According to some embodiments of the present disclosure, when the first inbound-interaction 150 is a voice interaction, recording the inbound-interaction to yield an audio file and operating speech-to-text technique on the audio file to generate the transcription file.

According to some embodiments of the present disclosure, the pretrained AI model may be trained by feeding stored interaction related data and metadata of the first inbound-interaction and the transcription file to a Machine Learning (ML) platform.

According to some embodiments of the present disclosure, the interaction related data may include summary of content of the inbound-interaction, customer queries, and discussion points. The pretrained AI model may be configured to provide one or more resolutions to the discussion points.

According to some embodiments of the present disclosure, optionally, after the first inbound-interaction 150 is disconnected, automatically connecting the customer to the second inbound-interaction 160.

According to some embodiments of the present disclosure, optionally, after the identifying of the second inbound-interaction 160 of the customer by the ACD application 130, sending the interaction related data via a digital communication channel to the customer before distributing the second inbound-interaction 160 to another agent by the ACD application 130.

According to some embodiments of the present disclosure, the following formula may provide a way to quantify and address the different impacts of a call disconnect, helping contact centers evaluate and mitigate the issues that arise when calls drop mid-conversation and a total Impact on Customer Experience (ICE) as a function of these factors. ICE is the overall term which calculates and sum up Repetition of information in minutes, Loss of context and Extended resolution time.

According to some embodiments of the present disclosure, the total Impact on Customer Experience (ICE) as a function of these factors, may be calculated according to formula I:

ICE=(RI*WRI)+(LC*WLC)+(ERT*WERT) (I)

whereby:
RI refers to Repetition of Information in minutes or score based on how much information was lost,
LC refers to Loss of Context (in minutes or score based on how much context was lost,
ERT refers to Extended Resolution Time in minutes or estimated extra time required, and
WRI, WLC, WERT refers to weight factors related to RI, LC and ERT, which represent the importance or severity of each issue in the specific context.

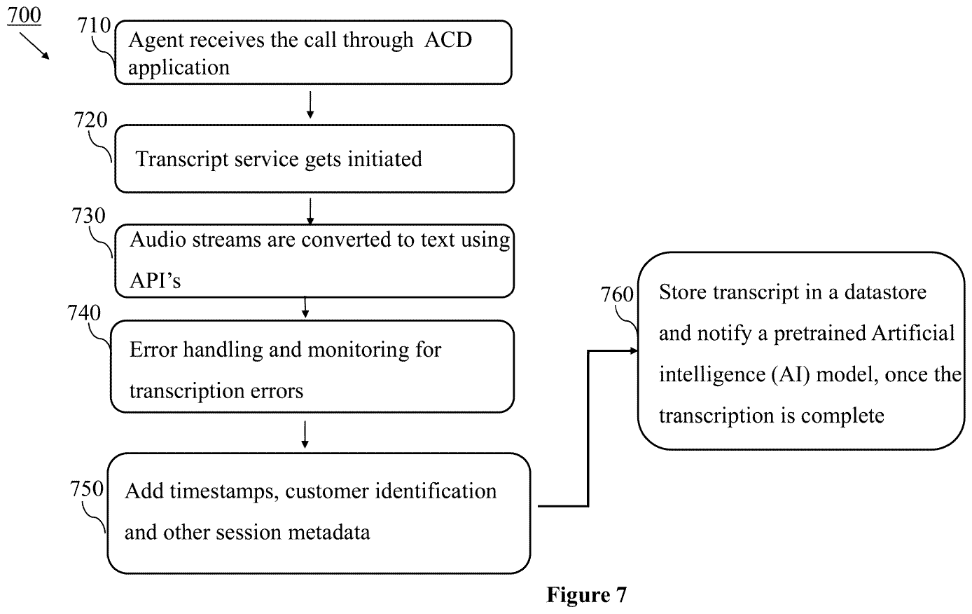

According to some embodiments of the present disclosure, ICE is a comprehensive term used to measure Loss of Context, Extended Resolution Time, and Repetition of Information. Internally, when utilizing the transcription service, e.g., as shown in element 760 in FIG. 7, calculating these metrics and storing the data in a database. Additionally, similar information is displayed in screenshot 1300 in FIG. 13, helping agents reduce the time spent collecting repetitive details. This, in turn, enhances the overall Impact on Customer Experience (ICE).

According to some embodiments of the present disclosure, the RI may be quantified based on the complexity of the issue, e.g., number of details the customer had to repeat. For example, if the customer had explained a complex issue, the repetition could be rated higher. The LC may be based on how much the new agent needs to be brought up to speed. If the previous agent documented the issue well, the loss of context would be minimal. If not, the weight would be higher. The ERT may relate to a situation where if a call disconnects and the customer needs to be transferred to a new agent, there is an added delay. This factor quantifies how much time is added to the overall resolution process.

According to some embodiments of the present disclosure, for example, if the customer had to repeat 6 minutes of information (RI=6), lost 3 minutes of context (LC=3), and faced an additional 10 minutes of resolution time (ERT =10), with the weights as defined, the calculated ICE may be,

ICE=(6*0.4)+(3*0.3)+(10*0.3)=2.4+0.9+3=6.3.

According to some embodiments of the present disclosure, in another example, if the customer had to repeat 5 minutes of information (RI=1), lost 0 minutes of context (LC=0), and faced an additional 2 minutes of resolution time (ERT=2), with the weights as defined, the calculated ICE may be,

ICE=(1*0.4)+(0*0.3)+(2*0.3)=0.4+0+0.6=1.0

According to some embodiments of the present disclosure, the higher the ICE score, the more negative the impact on the customer experience. Lower ICE scores would indicate less disruption and a smoother resolution process.

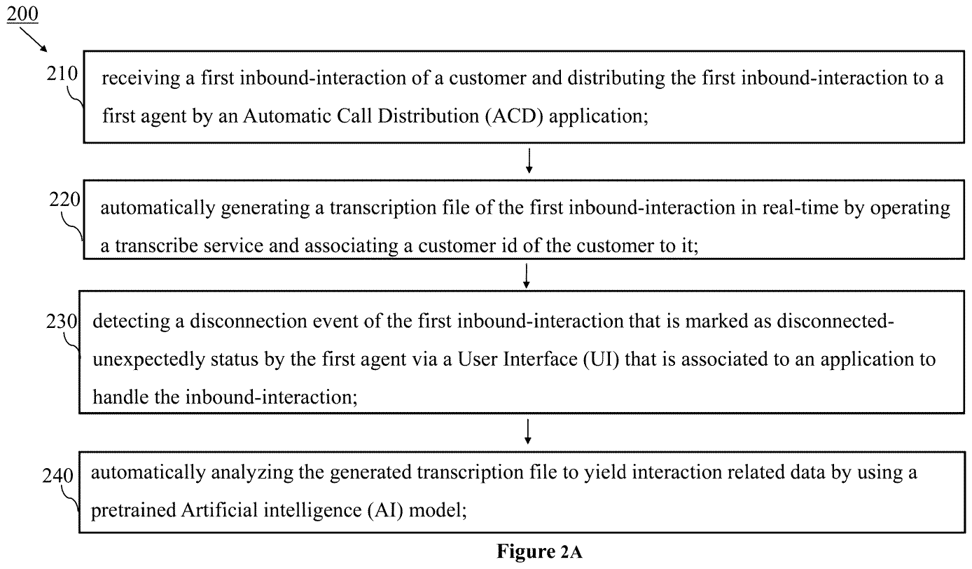

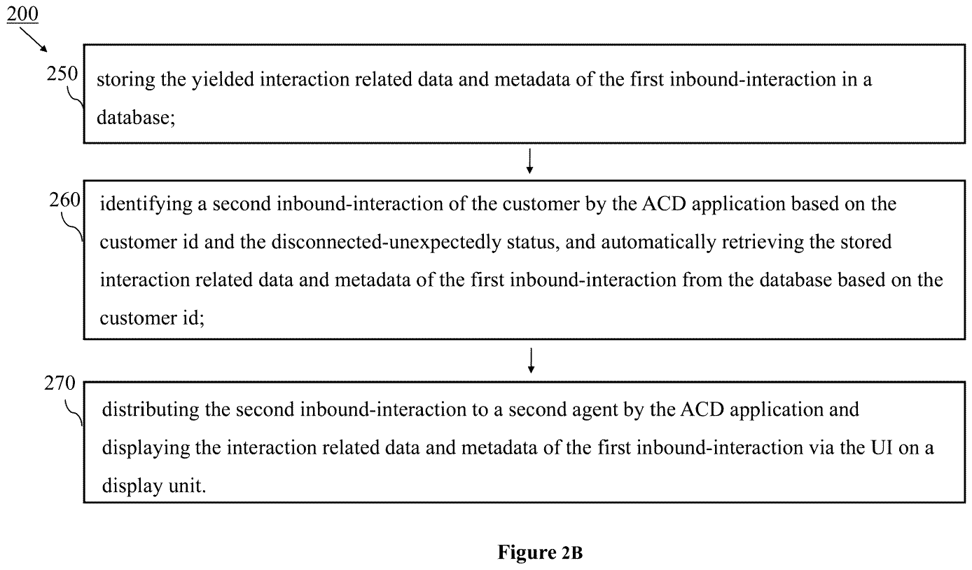

FIGS. 2A-2B are a high-level workflow 200 of resuming a disconnected inbound-interaction between an agent and a customer in a contact center, in accordance with some embodiments of the present disclosure.

According to some embodiments of the present disclosure, operation 210 comprising receiving a first inbound-interaction of a customer and distributing the first inbound-interaction to a first agent by an Automatic Call Distribution (ACD) application.

According to some embodiments of the present disclosure, operation 220 comprising automatically generating a transcription file of the first inbound-interaction in real-time by operating a transcribe service and associating a customer id of the customer to it.

According to some embodiments of the present disclosure, operation 230 comprising detecting a disconnection event of the first inbound-interaction that is marked as disconnected-unexpectedly status by the first agent via a User Interface (UI) that is associated to an application to handle the inbound-interaction.

According to some embodiments of the present disclosure, operation 240 comprising automatically analyzing the generated transcription file to yield interaction related data by using a pretrained Artificial intelligence (AI) model.

According to some embodiments of the present disclosure, operation 250 comprising storing the yielded interaction related data and metadata of the first inbound-interaction in a database.

According to some embodiments of the present disclosure, operation 260 comprising identifying a second inbound-interaction of the customer by the ACD application based on the customer id and the disconnected-unexpectedly status, and automatically retrieving the stored interaction related data and metadata of the first inbound-interaction from the database based on the customer id.

According to some embodiments of the present disclosure, operation 270 comprising distributing the second inbound-interaction to a second agent by the ACD application and displaying the interaction related data and metadata of the first inbound-interaction via the UI on a display unit.

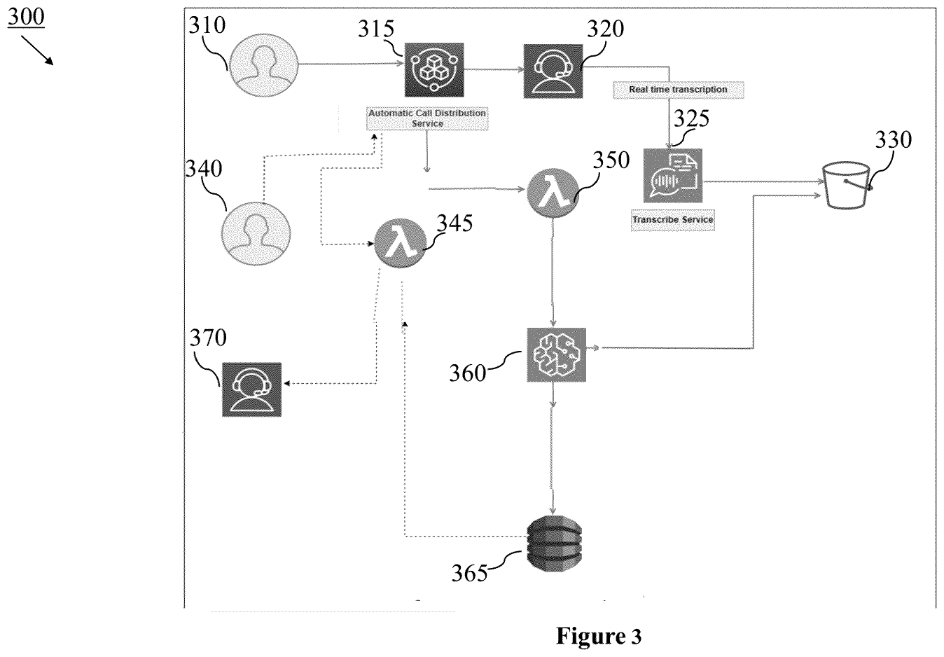

FIG. 3 schematically illustrates a high-level diagram of a system 300 for resuming a disconnected inbound-interaction between an agent and a customer in a contact center, in accordance with some embodiments of the present disclosure.

According to some embodiments of the present disclosure, in a system, such as computerized-system 100 in FIG. 1, when a customer calls the contact center 310, an automatic call distribution service may receive the call 315. This service, such as ACD application 130 in FIG. 1, may automatically route incoming calls to agents based on their skills, availability, and existing routing algorithms.

According to some embodiments of the present disclosure, once the call is received by the agent 320, a transcription service gets initiated 325 to operate real-time transcription of the call. The transcription service converts the speech to text making it easier to analyze and extract information from audio content.

According to some embodiments of the present disclosure, the transcript may be stored for the current inbound-interaction mapping against customer session id, and other details 330. The transcript and session details may be stored for example in a database, such as Amazon S3 bucket.

According to some embodiments of the present disclosure, after the call disconnects, the transcript may be analyzed to extract interaction related data. A Machine Learning (ML) service 360, such as Sagemaker of Amazon Web Services (AWS), may process the transcript by using a pretrained AI model and yield interaction related data. The interaction related data may include summary of the dialog in the disconnected inbound-interaction, extracted key customer queries and identified significant discussion points with possible resolutions, such as, a summary taken from the transcript which is highlighted by the pretrained AI model.

According to some embodiments of the present disclosure, the interaction related data may be stored in a database, such as database 120 in FIG. 1, for example Dynamo database 365.

According to some embodiments of the present disclosure, if the call gets disconnected in between conversation, an event is triggered to handle post-call processes for example, an AWS Lambda may be triggered by the disconnection event.

According to some embodiments of the present disclosure, the customer may call again after the first call has been disconnected 340 and then, the ACD application may operate a compute server, such as serverless compute service lambda of Amazon® to automatically identify the disconnected calls and identify a second inbound-interaction of the customer based on the customer id and the disconnected-unexpectedly status, and automatically retrieve the stored interaction related data and metadata of the first inbound-interaction from the database, based on the customer id 345.

According to some embodiments of the present disclosure, the ACD application may distribute the second inbound-interaction to a second agent 370 and the interaction related data and metadata of the first inbound-interaction may be displayed via the UI on a display unit. For example, as shown in screenshot 1300 in FIG. 13.

According to some embodiments of the present disclosure, system 300 may ensure continuity by leveraging real-time transcription, AI based analysis of the interactions, storage and retrieval of session data and seamless integration of the first inbound-interaction history when the customer reconnects.

According to some embodiments of the present disclosure, to address the issues caused by a customer call disconnecting mid-conversation with a contact center agent, a formula that considers these challenges, may be created based on call transcripts which reduces repetition of information, extended time and loss of context.

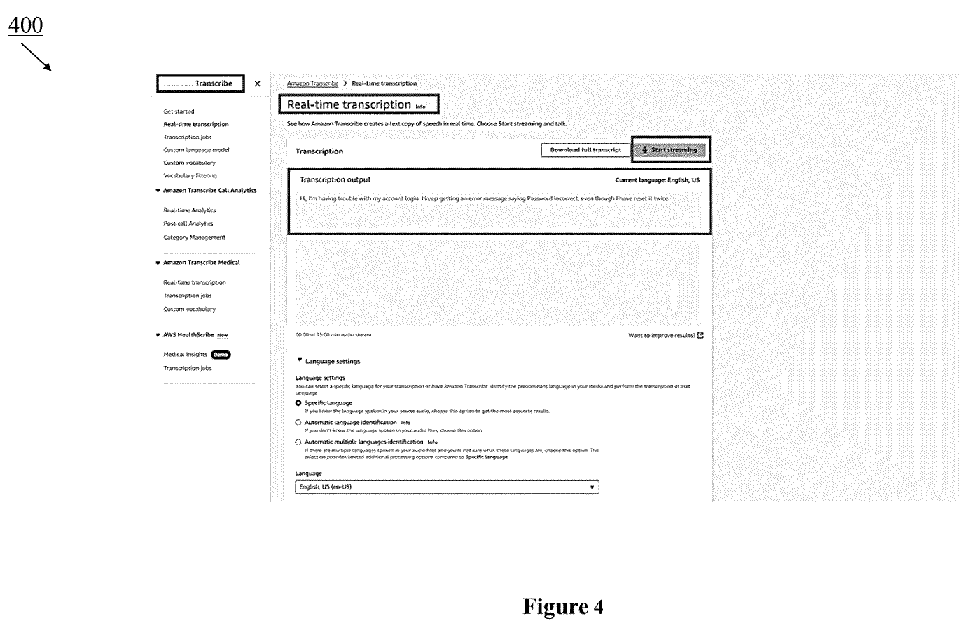

FIG. 4 is a screenshot 400 of the output of real-time transcription service, in accordance with some embodiments of the present disclosure.

According to some embodiments of the present disclosure, screenshot 400 displays Amazon Transcribe's real-time transcription feature, which converts speech to text instantly.

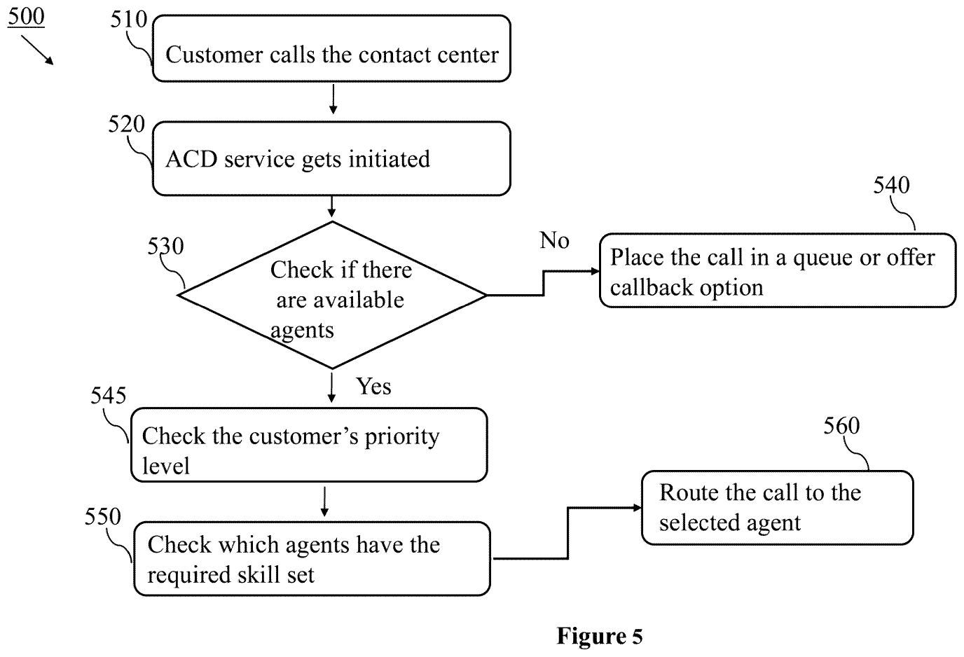

FIG. 5 is a high-level workflow 500 of routing calls through an Automatic Call Distribution (ACD) application, in accordance with some embodiments of the present disclosure.

According to some embodiments of the present disclosure, in a computerized-system, such as system 100 in FIG. 1, the ACD application, such as ACD application 130 in FIG. 1, may route the call to an available agent or hold the call in a queue if no agents are available. The ACD application may ensure that calls are routed to the appropriate agent based on skills, availability, or predefined rules. The decision-making logic ensures the right agent is connected to the customer.

According to some embodiments of the present disclosure, the customer may call the contact center 510 and the ACD service of the ACD application may get initiated 520.

According to some embodiments of the present disclosure, the ACD application may check if there are available agents 530. If there are no available agents, the ACD application may place the call in a queue or offer a callback option 540. If there are available agents, the ACD application may check the customer's priority level 545 and then check which agents have the required skill set 550 and route the call to the selected agents 560.

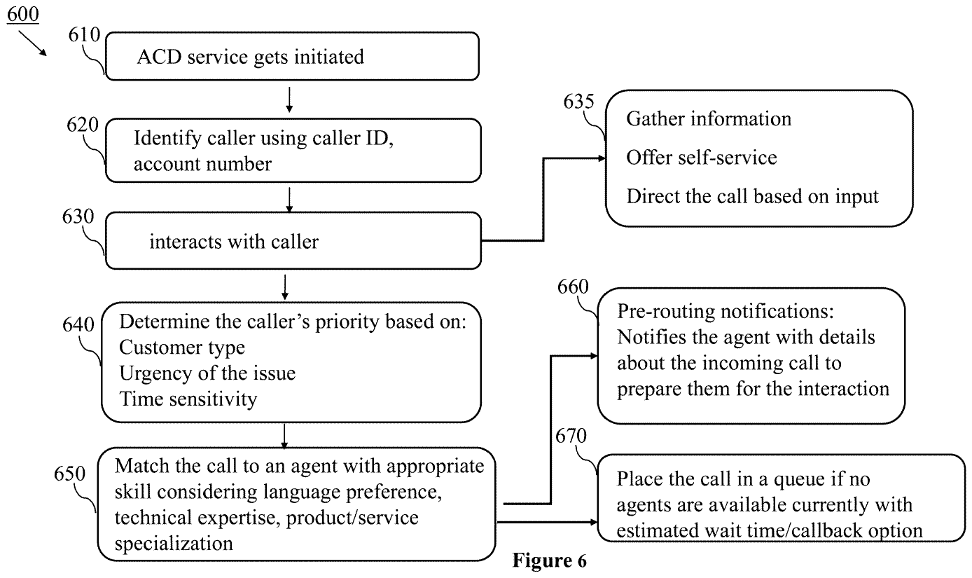

FIG. 6 is a detailed high-level workflow 600 of routing calls through an ACD application, in accordance with some embodiments of the present disclosure.

According to some embodiments of the present disclosure, in a computerized-system, such as system 100 in FIG. 1, the ACD application, such as ACD application 130 in FIG. 1, may become active and begin processing incoming calls by the ACD service getting initiated 610. An event-driven architecture may be implemented to trigger the ACD workflow upon detecting an incoming call.

According to some embodiments of the present disclosure, the ACD application may identify the caller by using caller ID and account number 620. it uses Application Programming Interfaces (API)s provided by telephony systems to fetch caller ID, and the account number. The ACD application may work with a CRM database to match the caller ID or account number with stored customer profiles and collects additional details, such as issue type or service needed, using Interactive Voice Response (IVR). Using this information the ACD application may decide the next steps in routing.

According to some embodiments of the present disclosure, the ACD application may interact with the caller 630 to gather information, offer self-service and direct the call based on input 635.

According to some embodiments of the present disclosure, the ACD application may consider factors, such as customer type, e.g., VIP, regular, new customer and urgency of the issue and time sensitivity. The ACD application may determine the priority of the call based on these factors 640. It uses CRM data to categorize customers.

According to some embodiments of the present disclosure, from database of agent profiles with skills, availability, and expertise it selects most suitable agent and assign the call to that agent. Before assigning the call, it notifies the agent with details about the incoming call, e.g. inbound-interaction, through screen-pop alert in the agent's UI. The ACD application may match the call to an agent with appropriate skill considering language preference, technical expertise, product/service specialization 650.

According to some embodiments of the present disclosure, if there is no suitable agent currently available, ACD application places the call in a queue with an estimated wait time or provides a callback option to the customer 670.

According to some embodiments of the present disclosure, the ACD application may provide pre-routing notifications and notify the agent, for example, by a screen pop-up, with details about the incoming call to prepare them for the interaction.

FIG. 7 is a high-level workflow 700 of a transcription service, in accordance with some embodiments of the present disclosure.

According to some embodiments of the present disclosure, in a computerized-system, such as system 100 in FIG. 1, when the agent receives the call through ACD application 710, an event-driven architecture transcription service gets initiated 720. The event may be named as ‘call connected’.

According to some embodiments of the present disclosure, audio streams are converted to text using API's 730 when the transcription system starts processing the audio streams of the ongoing call using APIs provided by a transcription service, such as Amazon Web Services (AWS)® Transcribe.

According to some embodiments of the present disclosure, error handling and monitoring for transcription errors 740 may be operated.

According to some embodiments of the present disclosure, timestamps, customer identification and other session metadata may be added 750 and the transcript may be stored in a datastore, such as S3 and notify a pretrained Artificial intelligence (AI) model, once the transcription is complete 760. The pretrained AI model may automatically analyze the generated transcription file to yield interaction related data which may be stored in a database with metadata of the inbound-interaction associated to the yielded transcript from the transcription.

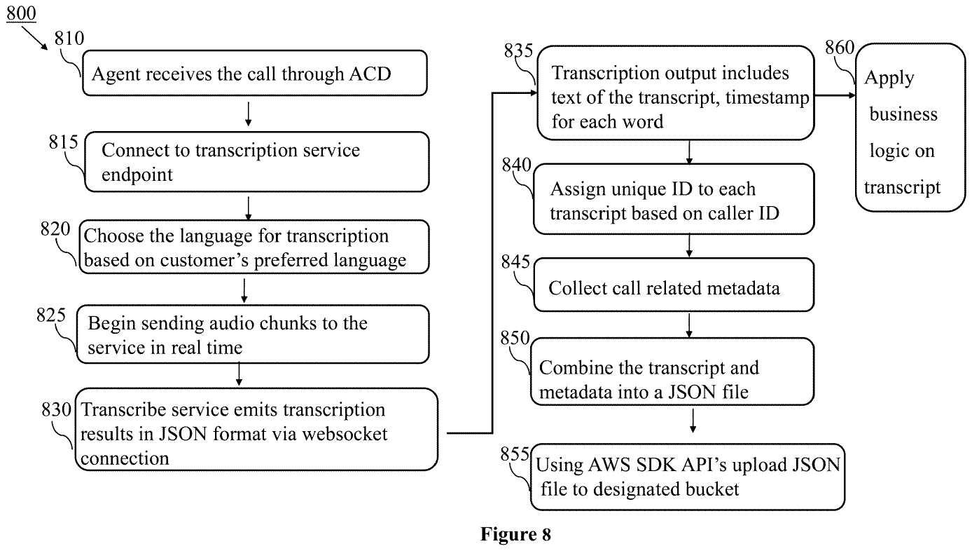

FIG. 8 is a detailed high-level workflow 800 of a transcription service, in accordance with some embodiments of the present disclosure.

According to some embodiments of the present disclosure, in a computerized-system, such as system 100 in FIG. 1, once the agent receives the call through ACS application 810, a websocket connection may be established to the transcription service endpoint 815, such as Amazon Transcribe service to enable real-time transcription of the interaction.

According to some embodiments of the present disclosure, the language for the real-time generated transcription may be chosen based on customer's preferred language 820. For example, the transcription language may be dynamically set based on the communication language chosen by the customer during Interactive voice response (IVR) interactions.

According to some embodiments of the present disclosure, using the Web Audio API, the system may record audio from the call system, which facilitates the inbound-interaction. It may begin sending audio chunks to the service in real time 825, such that the recorded audio is split into chunks and streamed to the transcription service, such as Amazon® Transcribe via the websocket connection.

According to some embodiments of the present disclosure, the transcription service may process the streamed audio and send back transcription results in JavaScript Object Notation (JSON) format through the same websocket connection. The transcription service may emit transactions results in JSON format via websocket connection 830.

According to some embodiments of the present disclosure, the transcription output may include text of the transcript, and timestamp for each word 835. Business logic may be applied to the transcript 860. For example, in a customer support call, a transcript may be generated with a timestamp for each word, such as “Hi, I'm having trouble with my account login. I keep getting an error message saying, ‘password incorrect,’ even though I've reset it twice”. . . By applying business logic, it provides the following generated summary: “Customer unable to log into their account due to persistent ‘password incorrect’ errors after multiple resets.”, Keyword Extraction Prompt: “Identify key issues and terms mentioned. and Generated Keywords: [“account login issue,” “password incorrect,” “multiple resets”]

According to some embodiments of the present disclosure, the transcription output may be processed to extract additional details, such as agent information, customer queries, and resolution details. Aa unique identifier may be generated based on the caller ID to track each transcription session and assigned to each transcript 840.

According to some embodiments of the present disclosure, the transcription text and metadata, e.g., timestamps, customer details, agent info, and the like may be merged into a structured JSON object. The finalized JSON object may be uploaded to a designated storage, such as S3 bucket using the AWS Software Development Kit (SDK) for long-term storage and later access.

According to some embodiments of the present disclosure, call related metadata may be collected 845 and the transcript and metadata may be combined into a JSON file 850.

According to some embodiments of the present disclosure, AWS SDK API's may be used to upload JSON file to designated bucket 855

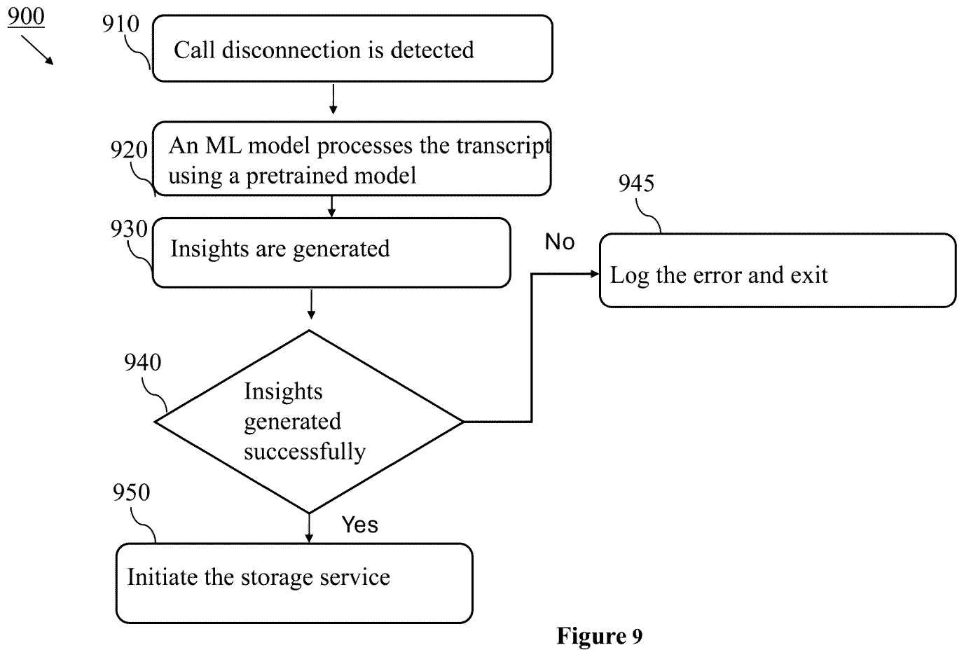

FIG. 9 is a high-level workflow 900 of a pretrained Artificial intelligence (AI) model initiation, in accordance with some embodiments of the present disclosure.

According to some embodiments of the present disclosure, in a computerized-system, such as system 100 in FIG. 1, a call disconnection may be detected 910. The Machine Learning (ML) service, such as Amazon® sagemaker may process the transcript using a pre-trained model 920. Insights e.g., interaction related data may be generated 930, such as summary of the conversation, key customer queries and other significant discussion points.

According to some embodiments of the present disclosure, the system may identify that a call between the customer and the agent has been unexpectedly disconnected which may trigger the a pretrained AI model to process the call's transcript and extract the insights, e.g., interaction related data.

According to some embodiments of the present disclosure, the Amazon® sagemaker may process the call transcript using a pre-trained AI model.

According to some embodiments of the present disclosure, the transcript may be received from the transcription service, such as Amazon® Transcribe service, containing the full conversation between the agent and the customer.

According to some embodiments of the present disclosure, the AI model may be designed to extract key insights, such as conversation summary, e.g., a brief overview of the discussion, customer query, e.g., the primary reason or issue for the call, possible resolution steps, e.g., actions taken during the call to resolve the issue, and key discussion points, any critical details shared by the agent or customer.

According to some embodiments of the present disclosure, checking if insights were generated successfully 940. When insights were not generated successfully, the errors may be logged 945. If insights were generated successfully, the insights may be stored in a storage service 950, such as Dynamo DB storage service, for further use.

According to some embodiments of the present disclosure, once the insights are generated the system initializes the DynamoDB service to store the structured data. The structured data may include Call ID, timestamp, metadata, e.g., agent and customer details and insights, such as the conversation summary, customer query, and resolution steps.

According to some embodiments of the present disclosure, the storage service, such as DynamoDB may provide efficient storage and retrieval of the insights for later usage.

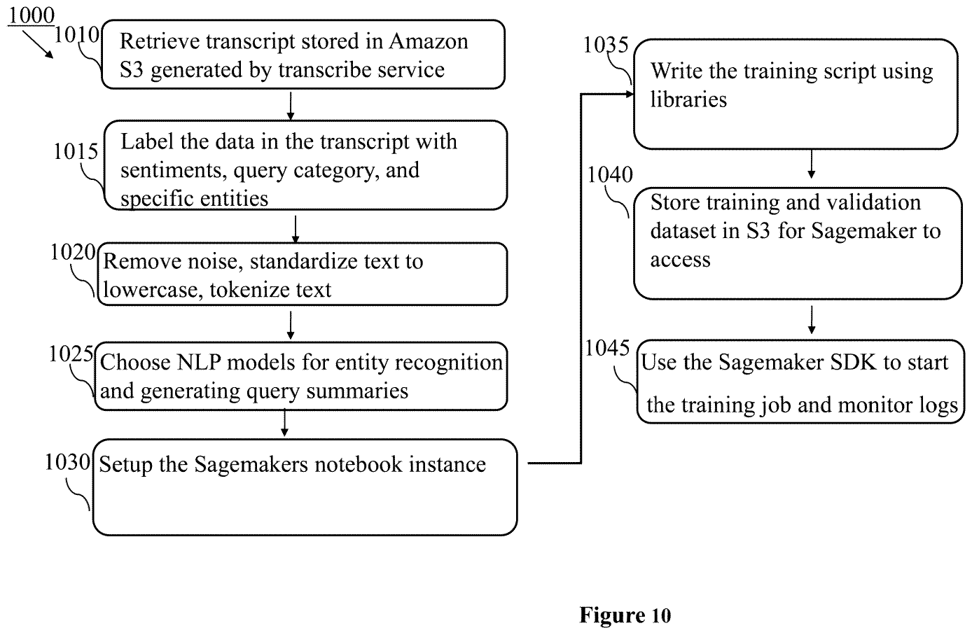

FIG. 10 is a high-level workflow 1000 of dataset preparation for the pretrained AI model, in accordance with some embodiments of the present disclosure.

According to some embodiments of the present disclosure, in a computerized-system, such as system 100 in FIG. 1, after obtaining the trained AI model, deploying it to a sagemaker endpoint. When a call disconnection event is triggered, the incoming transcript may be analyzed to generate insights, and save these insights to the storage service, e.g., DynamoDB.

According to some embodiments of the present disclosure, the transcript of an inbound-interaction stored in a database, such as Amazon S3 bucket, may be retrieved 1010. This transcript was generated by a transcription service and saved as a JSON file.

According to some embodiments of the present disclosure, the data in the transcript may be labeled with details, such as sentiments, query category and specific entities 1015. The query category may be a classification of the interaction into predefined categories, such as billing, technical support, or general Inquiry. The entities may be extracted entities, such as customer names, product names, or locations.

According to some embodiments of the present disclosure, the transcript may be cleaned and standardized for NLP model training by removing noise, standardize text to lowercase and tokenize text 1020. The noise may be removed by eliminating unnecessary characters or words, e.g., special characters, filler words like “um”. The text may be standardized for example, by converting all text to lowercase for consistency. During the tokenization process, the transcript may be broken down into individual words or phrases.

According to some embodiments of the present disclosure, NLP models may be chosen for entity recognition and query summary may be generated 1025. For example, advanced NLP models such as BERT or GPT, may be selected. These models may be used for tasks like entity recognition and summarize queries or generate query responses.

According to some embodiments of the present disclosure, set up sagemaker notebook instance 1030 by using Amazon® sagemaker to create a notebook instance for training and deploying the NLP models.

According to some embodiments of the present disclosure, writing the training script using libraries 1035 to create the script to train the NLP model. The dataset structure and preprocessing steps may be defined. The model's training loop, validation, and optimization logic may be implemented, for example, by using deep learning frameworks, such as PyTorch® or TensorFlow®.

According to some embodiments of the present disclosure, the training and validation datasets may be stored in a database, such as S3 for sagemaker to access 1040 during the training process.

According to some embodiments of the present disclosure, the AWS SDK may be used to upload the datasets to a designated S3 bucket.

According to some embodiments of the present disclosure, using the sagemaker SDK to initiate a training job and monitor logs 1045. Specifying the training script, instance type, and dataset locations. Then, monitoring training progress and logs through the sagemaker console or SDK. Once the training is complete, the model is ready to generate insights from new conversations, e.g., inbound interactions.

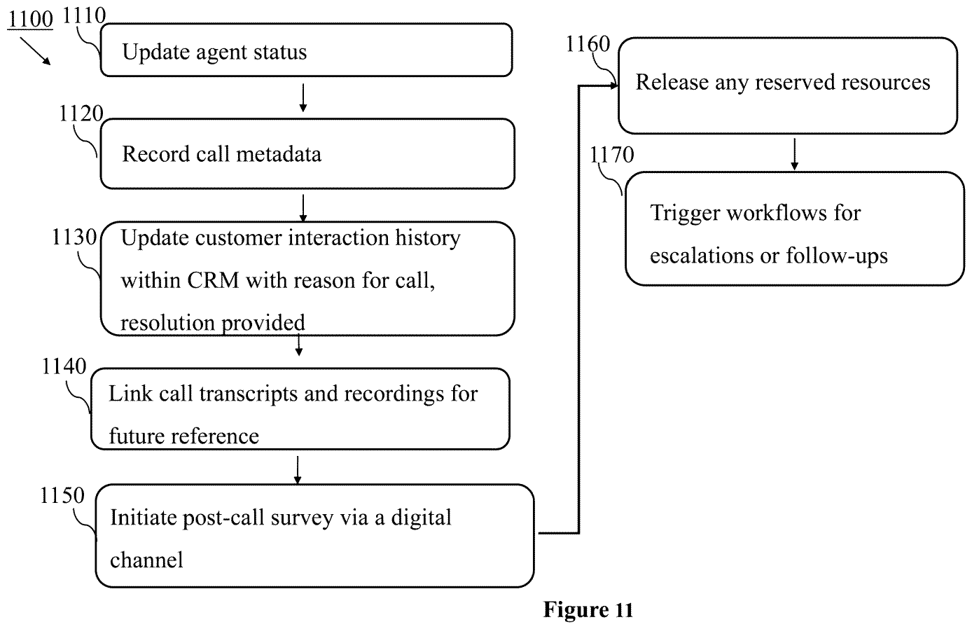

FIG. 11 is a high-level workflow 1100 of ACD application operation after a call is disconnected, in accordance with some embodiments of the present disclosure.

According to some embodiments of the present disclosure, in a computerized-system, such as system 100 in FIG. 1, after the call ends, the agent's status is updated in the system 1110 e.g., ‘Available’, ‘Busy’, to reflect their availability for new calls.

According to some embodiments of the present disclosure, record call, e.g., interaction metadata 1120, to capture details, such as the call's start and end times, duration, and call disposition, e.g. Resolved, Escalated. This information is critical for analytics and reporting.

According to some embodiments of the present disclosure, update customer interaction history within CRM with reason for call and resolution provided 1130. The customer interaction may be logged in the CRM system, including the reason for the call and the resolution provided. This ensures a complete record of customer interactions for future reference.

According to some embodiments of the present disclosure, call transcripts may be linked to recordings for future reference 1140, by attaching the transcript and the call recording to the customer's record in the CRM system for easy retrieval during future interactions.

According to some embodiments of the present disclosure, initiate post-call survey via a digital channel 1150. Trigger a customer satisfaction survey via IVR, SMS, or email to gather feedback on the interaction.

According to some embodiments of the present disclosure, release any reserved resources 1160 by freeing up any resources allocated to the call, such as phone lines, conference bridges, or call queues, making them available for new calls.

According to some embodiments of the present disclosure, trigger workflow for escalation or follow-ups 1170.

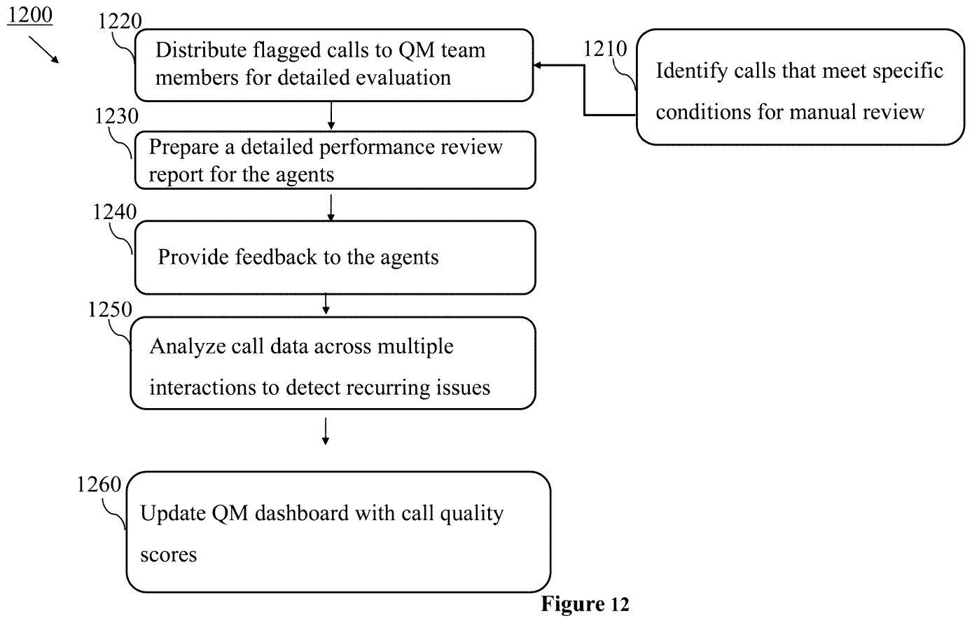

FIG. 12 is a high-level workflow 1200 of Quality Management (QM) application operations after a call is disconnected, in accordance with some embodiments of the present disclosure.

According to some embodiments of the present disclosure, in a computerized-system, such as system 100 in FIG. 1, the system flags calls that meet certain criteria, such as long durations, escalations, or unresolved issues, for manual review. These flagged calls are assigned to Quality Management (QM) team members for detailed evaluation.

According to some embodiments of the present disclosure, calls that meet specific conditions for manual review may be identified 1210. The flagged calls may be distributed to QM team members for detailed evaluation 1220.

According to some embodiments of the present disclosure, the QM team may prepare a detailed performance review report for the agents 1230. The QM team evaluates the flagged calls and compiles a report highlighting areas where the agent excelled or needs improvement.

According to some embodiments of the present disclosure, feedback may be provided to the agents 1240. Based on the performance report, feedback is shared with agents to help them improve future interactions.

According to some embodiments of the present disclosure, analyze call data across multiple interactions to detect recurring issues 1250. The system aggregates call data over time to identify recurring issues or trends in customer interactions. Quality scores and insights are updated in a QM dashboard to track agent performance and overall call quality.

According to some embodiments of the present disclosure, update QM dashboard with call quality scores 1260.

FIG. 13 is a screenshot 1300 of interaction related data and metadata of an inbound-interaction presented via the UI on a display unit, in accordance with some embodiments of the present disclosure.

According to some embodiments of the present disclosure, the interaction related data and metadata of the first inbound-interaction may be displayed via the UI on a display unit. By clicking on a link for full transcript, and disconnect call analytics, it may be presented as shown in FIG. 4.

According to some embodiments of the present disclosure, the popup may be displayed to the agent when they click on the button located in the right-hand side section labeled ‘Customer Call Disconnected Analytics.’ This button becomes visible only when the system detects and associates any disconnected context with the current call session.

According to some embodiments of the present disclosure, the purpose of this popup is to provide the agent with critical details from previously disconnected calls. This helps prevent the repetition of information and minimizes the loss of context, ensuring a more seamless and efficient interaction.

According to some embodiments of the present disclosure, the popup may display the following information to the agent: Session ID: EDFHGT-2345 which is an example of a unique identifier for the interaction session. It helps track and reference the specific conversation or case. Customer Name: Sara. The name of the customer who contacted support. Previous Agent Name: John

The name of the agent who handled the previous interaction with the customer. This indicates continuity in support. Issues: The customer reported a “Discrepancy in credit card charges and extra fees on the statement.” This describes the nature of the problem Sara is experiencing.

According to some embodiments of the present disclosure, the button ‘Click for full transcript’ may link to a detailed transcript of the session, providing full details of the interaction, including conversations, timestamps, and any actions taken. This popup may also provide a navigation link to the full transcript of the previously disconnected call. This feature enables the agent to gain deeper insights into the customer's issue from the prior session, offering valuable context for resolving the current interaction more effectively.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

What is claimed:

1. A computerized-method for resuming a disconnected inbound-interaction between an agent and a customer in a contact center, said computerized-method comprising:
(i) receiving a first inbound-interaction of a customer and distributing the first inbound-interaction to a first agent by an Automatic Call Distribution (ACD) application;
(ii) automatically generating a transcription file of the first inbound-interaction in real-time by operating a transcribe service and associating a customer id of the customer to it;
(iii) detecting a disconnection event of the first inbound-interaction that is marked as disconnected-unexpectedly status by the first agent via a User Interface (UI) that is associated to an application to handle the inbound-interaction;
(iv) automatically analyzing the generated transcription file to yield interaction related data by using a pretrained Artificial intelligence (AI) model;
(v) storing the yielded interaction related data and metadata of the first inbound-interaction in a database;
(vi) identifying a second inbound-interaction of the customer by the ACD application based on the customer id and the disconnected-unexpectedly status, and automatically retrieving the stored interaction related data and metadata of the first inbound-interaction from the database based on the customer id; and
(vii) distributing the second inbound-interaction to a second agent by the ACD application and displaying the interaction related data and metadata of the first inbound-interaction via the UI on a display unit.

2. The computerized-method of claim 1, wherein when the first inbound-interaction is a voice interaction, recording the inbound-interaction to yield an audio file and operating speech-to-text technique on the audio file to generate the transcription file.

3. The computerized-method of claim 1, wherein the pretrained AI model is trained by feeding stored interaction related data and metadata of the first inbound-interaction and the transcription file to a Machine Learning (ML) platform.

4. The computerized-method of claim 1, wherein the interaction related data comprising at least one of: (i) summary of content of the inbound-interaction; (ii) customer queries; and (iii) discussion points, and wherein said pretrained AI model is configured to provide one or more resolutions to the discussion points.

5. The computerized-method of claim 1, wherein after the first inbound-interaction is disconnected, said computerized-method is further comprising automatically connecting the customer to the second inbound-interaction.

6. The computerized-method of claim 1, wherein after the identifying of the second inbound-interaction of the customer by the ACD application, said computerized-method is further comprising sending the interaction related data via a digital communication channel to the customer before distributing the second inbound-interaction to the second agent by the ACD application.

7. A computerized-system for resuming a disconnected inbound-interaction between an agent and a customer in a contact center, said computerized-system comprising:
an Automatic Call Distribution (ACD) application;
a User Interface (UI);
a display unit;
a database, and
one or more processors,
upon receiving a first inbound-interaction of a customer and distributing the first inbound-interaction to a first agent by the ACD application, said one or more processors are configured to:
(i) automatically generate a transcription file of the first inbound-interaction in real-time by operating a transcribe service and associating a customer id of the customer to it;
(ii) detect a disconnection event of the first inbound-interaction that is marked as disconnected-unexpectedly status by the first agent via a User Interface (UI) that is associated to an application to handle the inbound-interaction;
(iii) automatically analyze the generated transcription file to yield interaction related data by using a pretrained Artificial intelligence (AI) model;
(iv) store the yielded interaction related data and metadata of the first inbound-interaction in a database;
(v) identify a second inbound-interaction of the customer by the ACD application based on the customer id and the disconnected-unexpectedly status, and automatically retrieving the stored interaction related data and metadata of the first inbound-interaction from the database based on the customer id; and
(vi) distribute the second inbound-interaction to a second agent by the ACD application and displaying the interaction related data and metadata of the first inbound-interaction via the User Interface (UI) on the display unit.
